(19) United States
(12) Patent Application Publication
(10) Pub. No.: US 2024/0221018 A1
(43) Pub. Date: Jul. 4, 2024

(54) METHOD AND ELECTRONIC DEVICE FOR PROVIDING INFORMATION BY USING REINFORCEMENT LEARNING

(71) Applicant: SAMSUNG ELECTRONICS CO., LTD., Suwon-si (KR)

(72) Inventors: Hongjun JANG, Suwon-si (KR); Eunkyu OH, Suwon-si (KR); Minsoo KIM, Suwon-si (KR); Taehun KIM, Suwon-si (KR); Yunhu JI, Suwon-si (KR)

(73) Assignee: SAMSUNG ELECTRONICS CO., LTD., Suwon-si (KR)

(21) Appl. No.: 18/403,403

(22) Filed: Jan. 3, 2024

Related U.S. Application Data
(63) Continuation of application No. PCT/KR24/00122, filed on Jan. 3, 2024.

(30) Foreign Application Priority Data
Jan. 3, 2023 (KR) 10-2023-0000906

(51) Int. Cl. G06Q 30/0211; G06Q 30/0207

(52) U.S. Cl. CPC G06Q 30/0211; G06Q 30/0239; G06N 5/04

(57) ABSTRACT

A method by which an electronic device provides a service to a user, includes: obtaining data related to at least one of the user, a plurality of products, or one or more marketing activities; identifying the user's purchase intention based on the data; identifying at least one product combination comprising two or more products from among the plurality of products and a discount rate of the at least one product combination by applying the identified user's purchase intention and the data to an artificial intelligence (AI) model; and displaying, on a display of the electronic device, the at least one product combination and the discount rate.

### CROSS-REFERENCE TO RELATED APPLICATIONS

This application is a continuation of PCT International Application No. PCT/KR2024/000122, filed on Jan. 3, 2024, which is based on and claims priority to Korean Patent Application No. 10-2023-0000906, filed on Jan. 3, 2023, in the Korean Intellectual Property Office, the disclosures of which are incorporated by reference herein their entireties.

### BACKGROUND

### 1. Field

The disclosure relates to a method and an electronic device for providing a product combination by using reinforcement learning.

### 2. Description of Related Art

With the development of technology in online services and communication systems, customized promotions for users are provided in various forms and by using various methods. Electronic devices generate and provide promotions suitable for users through learning.

With the recent development of artificial intelligence (AI) technology, a discount rate may be calculated for each product and may be provided to a user. Compared to offline purchases, online purchases need to provide more suitable benefits to users considering a low purchase probability and a low repurchase probability compared to products viewed by online users. Online purchases need to recommend products by reflecting users' feedback on promotions and provide promotions with discount rates considering a low probability of repurchasing by users through online services.

### SUMMARY

According to an aspect of the disclosure, a method by which an electronic device provides a service to a user, includes: obtaining data related to at least one of the user, a plurality of products, or one or more marketing activities; identifying a purchase intention of the user based on the data; identifying at least one product combination comprising two or more products from among the plurality of products and a discount rate of the at least one product combination by applying the identified user's purchase intention and the data to an artificial intelligence (AI) model; and displaying, on a display of the electronic device, the at least one product combination and the discount rate.

According to an aspect of the disclosure, an electronic device for providing a service to a user, includes: a transceiver; a memory in which one or more instructions are stored; at least one processor configured to execute the one or more instructions to: obtain data related to at least one of the user, a plurality of products, or one or more marketing activities, identify the user's purchase intention based on the data, identify at least one product combination comprising two or more products from among the plurality of products and a discount rate of the at least one product combination, by applying the identified user's purchase intention and the data to an artificial intelligence (AI) model, and display, on a display of the electronic device, the at least one product combination and the discount rate.

According to an aspect of the disclosure, a non-transitory computer-readable recording medium has recorded thereon a program for executing a method comprising: obtaining data related to at least one of the user, a plurality of products, or one or more marketing activities; identifying the user's purchase intention based on the data; identifying at least one product combination comprising two or more products from among the plurality of products and a discount rate of the at least one product combination by applying the identified user's purchase intention and the data to an artificial intelligence (AI) model; and displaying, on a display of the electronic device, the at least one product combination and the discount rate.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for describing a method by which an electronic device provides a promotion, according to an embodiment of the disclosure;

FIG. 2 is a diagram for describing an example of a promotion provided by an electronic device, according to an embodiment of the disclosure;

FIG. 3 is a flowchart for describing a method by which an electronic device provides a promotion, according to an embodiment of the disclosure;

FIG. 4 is a flowchart for describing a method by which an electronic device provides a promotion by using reinforcement learning, according to an embodiment of the disclosure;

FIG. 5 is a diagram for describing an example of data obtained through an interaction between a user and an online service, according to an embodiment of the disclosure;

FIG. 6 is a diagram for describing a method of inferring a product combination, according to an embodiment of the disclosure;

FIG. 7 is a diagram for describing an inference process in a reinforcement learning algorithm, according to an embodiment of the disclosure;

FIG. 8 is a diagram for describing an example of providing a promotion according to a user's priority, according to an embodiment of the disclosure;

FIG. 9 is a diagram for describing time information included in data, according to an embodiment of the disclosure;

FIG. 10 is a diagram for describing a method of considering time information in an algorithm, according to an embodiment of the disclosure;

FIG. 11 is a diagram for describing an algorithm by which an electronic device provides a promotion, according to an embodiment of the disclosure; and

FIG. 12 is a schematic block diagram illustrating an electronic device, according to an embodiment of the disclosure.

### DETAILED DESCRIPTION

Embodiments of the disclosure will now be described more fully with reference to the accompanying drawings.

As the disclosure allows for various changes and numerous examples, particular embodiments of the disclosure will be illustrated in the drawings and described in detail in the written description. However, this is not intended to limit the disclosure to particular modes of practice, and it will be understood that all changes, equivalents, and substitutes that do not depart from the spirit and technical scope of various embodiments are encompassed in the disclosure.

In the description of embodiments, certain detailed explanations of related art are omitted when it is deemed that they may unnecessarily obscure the essence of the disclosure. Also, numbers (e.g., first and second) used in the description of the specification are merely identifier codes for distinguishing one element from another.

The terms used herein are those general terms currently widely used in the art in consideration of functions in the disclosure but the terms may vary according to the intention of one of ordinary skill in the art, precedents, or new technology in the art. Also, some of the terms used herein may be arbitrarily chosen by the present applicant, and in this case, these terms are defined in detail below. Accordingly, the specific terms used herein should be defined based on the unique meanings thereof and the whole context of the disclosure.

The scope of the disclosure may be defined by the claims described below rather than the detailed description. Various features included only in one claim category (e.g., method claim) may be claimed in other claim categories (e.g., system claim). Also, an embodiment of the disclosure may include not only a combination of features specified in the appended claims but also various combinations of individual features within the claims. The scope of the disclosure is defined by the following claims, and it is intended that the disclosure cover modifications or variations of the disclosure provided they come within the scope of the appended claims and their equivalents.

Also, in the disclosure, regarding an element represented as a ‘ . . . unit’ or a ‘module’, two or more elements may be combined into one element or one element may be divided into two or more elements according to subdivided functions. These functions may be implemented as hardware, software, or a combination of hardware and software. In addition, each element described hereinafter may additionally perform some or all of functions performed by another element, in addition to main functions of itself, and some of the main functions of each element may be performed entirely by another element.

As used herein, the singular expressions are intended to include plural forms as well, unless the context clearly indicates otherwise. Terms used herein, including technical or scientific terms, may have the same meaning as commonly understood by one of ordinary skill in the art described in the disclosure.

Throughout the disclosure, “or” is inclusive and not exclusive, unless otherwise described. Accordingly, unless clearly indicated otherwise or the context indicates otherwise, the expression “A or B” may include A, may include B, or may include both A and B. In the disclosure, the phrase “at least one of” or “one or more”, when used with a list of items, means that different combinations of one or more of the listed items may be used or that only one item in the list may be needed. For example, “at least one of A, B, or C” may include any of the following combinations: A, B, C, A and B, A and C, B and C, or A and B and C.

It will be understood that each block of flowchart illustrations and combinations of blocks in the flowchart illustrations may be implemented by computer program instructions. Because these computer program instructions may be loaded into a processor of a general-purpose computer, special purpose computer, or other programmable data processing equipment, the instructions, which are executed via the processor of the computer or other programmable data processing equipment generate means for performing the functions specified in the flowchart block(s). Because these computer program instructions may also be stored in a computer-executable or computer-readable memory that may direct the computer or other programmable data processing equipment to function in a particular manner, the instructions stored in the computer-executable or computer-readable memory may produce an article of manufacture including instruction means for performing the functions stored in the flowchart block(s). Because the computer program instructions may also be loaded into a computer or other programmable data processing equipment, a series of operational steps may be performed on the computer or other programmable data processing equipment to produce a computer implemented process, and thus, the instructions executed on the computer or other programmable data processing equipment may provide steps for implementing the functions specified in the flowchart block(s).

Also, each block may represent a module, segment, or portion of code, which includes one or more executable instructions for implementing specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

A function related to artificial intelligence (AI) according to the disclosure is performed by a processor and a memory. The processor may include one or more processors. For example, the one or more processors may include a general-purpose processor such as a central processing unit (CPU), an application processor (AP), or a digital signal processor (DSP), a dedicated graphics processor such as a graphics processing unit (GPU) or a vision processing unit (VPU), or an AI processor such as a neural processing unit (NPU). The one or more processors control input data to be processed according to a predefined operation rule or an AI model stored in the memory. In one or more examples, when the one or more processors are AI processors, the AI processor may be designed as a hardware structure specialized in processing a specific AI model.

The predefined operation rule or the AI model may be generated through learning. In one or more examples, “generated through learning” may mean that, as a basic AI model is trained by using a plurality of pieces of training data according to a learning algorithm, a predefined operation rule or AI model set to perform desired characteristics (or purposes) is generated. Such learning may be performed on a device in which AI according to the disclosure is conducted or may be performed through a separate server and/or system. Examples of the learning algorithm include, but are not limited to, supervised learning, unsupervised learning, semi-supervised learning, and reinforcement learning.

The AI model may include a plurality of neural network layers. The plurality of neural network layers have a plurality of weight values, and a neural network operation is performed through an operation between an operation result of a previous layer and the plurality of weight values. The plurality of weight values of the neural network layers may be optimized by a result of training the AI model. For example, the plurality of weight values may be refined to reduce or optimize a loss value or a cost value obtained by the AI model during a training procedure. An artificial neural network may include a deep neural network (DNN), and may include, but is not limited to, a convolutional neural network (CNN), a DNN, a recurrent neural network (RNN), a restricted Boltzmann machine (RBM), a deep belief network (DBN), a bidirectional recurrent deep neural network (BRDNN), or a deep Q-network,

Hereinafter, an embodiment of the disclosure will be described in detail with reference to the accompanying drawings so that one of ordinary skill in the art may easily implement the disclosure. However, the disclosure may be implemented in various different forms and is not limited to the embodiments described herein. Also, in the drawings, like reference numerals designate like elements throughout the specification.

The terms used herein will be briefly described, and an embodiment of the disclosure will be described in detail.

The terms used herein are those defined in consideration of functions in the disclosure, but the terms may vary according to the intention of users or operators, precedents, etc. Hence, the terms used herein should be defined based on the meaning of the terms together with the descriptions throughout the specification.

In the disclosure, a ‘user's purchase intention’ may refer to a user's purchase intention for all unspecified products rather than a specific product. That is, a user's purchase intention may refer to a user's intention to purchase.

In the disclosure, a ‘reward value’ may refer to a reward reflected as a feedback to perform reinforcement learning.

In the disclosure, a ‘product group’ is a collection of products that are grouped according to a type, and may refer to a group of products with a certain similarity or higher.

In the disclosure, a ‘flagship’ product may refer to a representative product or a main product from among a plurality of products.

In the disclosure, a ‘logit value’ may refer to decision-making reliability.

In the disclosure, an ‘action space’ may refer to a set of all actions possible in a given environment.

In the disclosure, a ‘hidden layer’ may refer to a layer that is located between an input layer and an output layer of an AI model and forms a single neural network by continuously connecting the model.

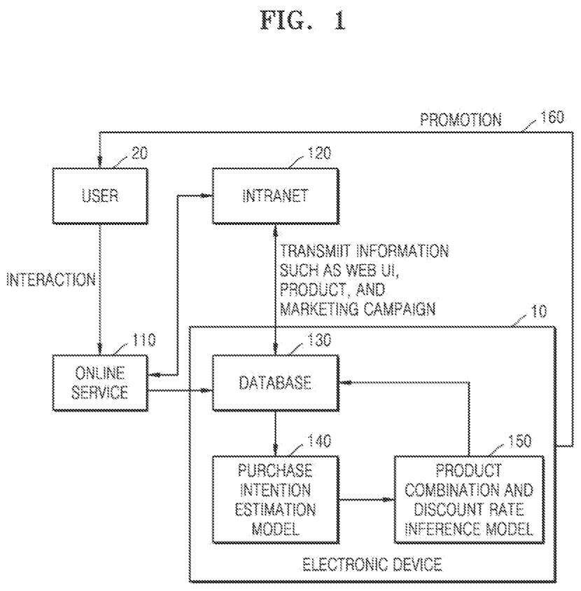

FIG. 1 is a diagram for describing a method by which an electronic device provides a promotion, according to an embodiment of the disclosure.

Referring to FIG. 1, a method of providing a promotion to a user may comprise an electronic device 10. In an embodiment of the disclosure, the electronic device 10 may determine and provide a promotion 160 through AI models (e.g., 140 and 150) using reinforcement learning based on data obtained from an intranet 120 or an online service 110 interacting with a user 20.

The electronic device 10, according to an embodiment of the disclosure, may be a device including a display. The electronic device 10 may be a device that outputs the obtained promotion through the display. Examples of the electronic device 10 according to the disclosure may include, but are not limited to, a smart TV, a smartphone, a tablet PC, a laptop computer, an e-book terminal, a digital broadcasting terminal, a personal digital assistant (PDA), a portable multimedia player (PMP), or any other suitable device known to one of ordinary skill in the art. The electronic device 10 may be implemented as any of various types of electronic devices including a display.

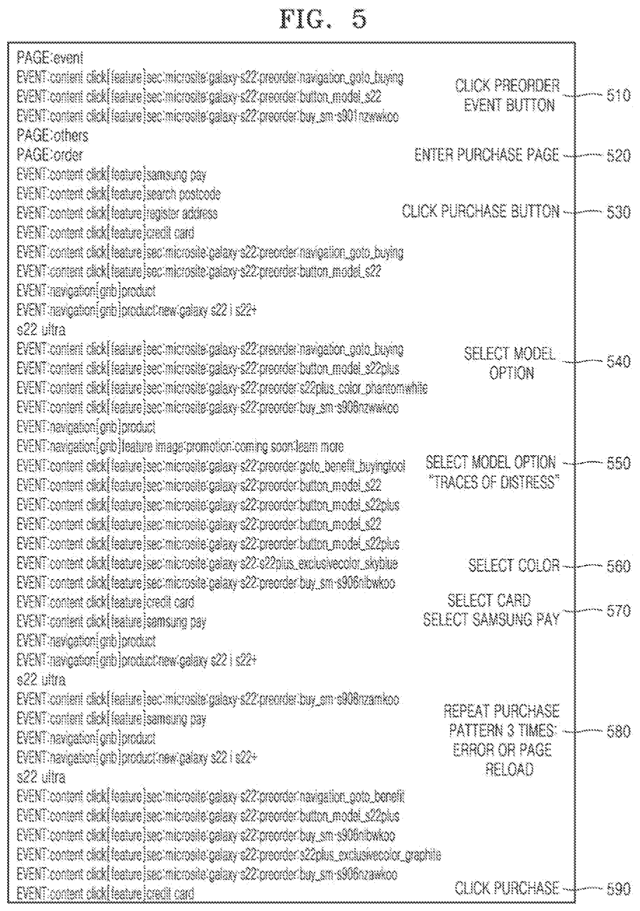

The electronic device 10 may obtain data related to the user from the online service 110 interacting with the user 20. In one or more examples, the electronic device 10 may obtain data related to a plurality of users. Examples of the data related to the user may include, but are not limited to, user behavior data, location information using location or tracking services associated with a user's electronic device, channel information (e.g., website, social media page) through which the user enters, accessed device information, and campaign information through which the user enters, and may include any and all data generated while the user 20 interacts with the online service 110. Specific examples of the data will be described below with reference to FIG. 5.

The electronic device 10 may obtain data related to a product or marketing from the intranet 120. Examples of the data related to the product may include, but are not limited to, information about the product published to the user, a product group to which the product belongs, a name of the product, an ID of the product, and information about a price of the product. Examples of the data related to the marketing may include, but are not limited to, a type of a campaign, statistics of sales from the marketing or the campaign, a duration of the marketing, a discount rate according to the marketing, an ID of the campaign, information related to social media advertising, and information related to an email marketing campaign.

In one or more examples, the data obtained by the electronic device 10 may include a time for which the user 20 maintains a page within a session and a time interval between pages. The electronic device 10 may store the obtained data in a database 130.

In an embodiment of the disclosure, the electronic device 10 may perform preprocessing on the obtained data or the data stored in the database 130 to be suitable for an AI model. The preprocessing of the data may enable effective learning using high-level training data by converting the data into data that may be understood by the AI model or improving the quality of the data. The electronic device 10 may convert the obtained data into a one-dimensional vector or integer value to generate and utilize one one-dimensional vector. The electronic device 10 may use the preprocessed data as an input to an AI model for identifying a purchase intention or an AI model for inferring a product combination and a discount rate. Also, in an embodiment of the disclosure, the electronic device 10 may store the preprocessed data in the database 130 or may update the stored data.

In an embodiment of the disclosure, the electronic device 10 may estimate a purchase intention of the user 20 through a purchase intention estimation model 140 having the obtained or preprocessed data or the data stored in the database 130 as an input value. A ‘user's purchase intention’ in the disclosure may refer to a user's purchase intention for all unspecified products rather than the user's purchase intention for a specific product. In one or more examples, a specific product may refer to a product that is already purchased by the user. The purchase intention estimation model 140 may be implemented as an algorithm based on the obtained data. The purchase intention estimation model 140 may be a deep neural network-based classification inference model. The purchase intention estimation model 140 may identify that the user's purchase intention exists when a probability that the user purchases the product is equal to or greater than a preset probability. The purchase intention estimation model 140 may output ‘1’ (or ‘0’) as an output value when it is identified that the user's purchase intention exists and may output ‘0’ (or ‘1’) as an output value when it is identified that there is no user's purchase intention. In one or more examples, the electronic device 10 may infer a purchase intention of the user 20 through the purchase intention estimation model 140 until a certain number of input and output values are obtained.

In an embodiment of the disclosure, when it is determined that the user's purchase intention exits, the electronic device 10 may provide the promotion 160 to the user 20 by using a product combination and discount rate inference model 150 having the data on the user as an input value.

The purchase intention estimation model 140 and the product combination and discount rate inference model 150 may be different AI models. In one or more examples, the purchase intention estimation model 140 may be implemented as a simple algorithm, and the product combination and discount rate inference model 150 may be implemented as an AI model. As the models operate independently of each other, the product combination and discount rate inference model 150 may be trained only using data with a purchase intention, thereby advantageously increasing sample efficiency and reducing a training time.

In an embodiment of the disclosure, the product combination and discount rate inference model 150 may calculate a preferred product group and model for each user. Because a product combination and a discount rate are inferred by the same model, weight values of a deep neural network may interact. A product combination may include two or more products and may include products belonging to different product groups. The product combination and discount rate inference model 150 may perform reinforcement learning by reflecting the user's feedback according to a product combination or a discount rate of the product combination through a reward function.

In an embodiment of the disclosure, the product combination and discount rate inference model 150 may identify a combination of products based on a relationship between different product groups. The relationship between product groups may be classified into a preference between product groups according to a customer experience journey, a preference between product groups for each inflow channel or network, and a preference between product groups for each inflow digital marketing campaign.

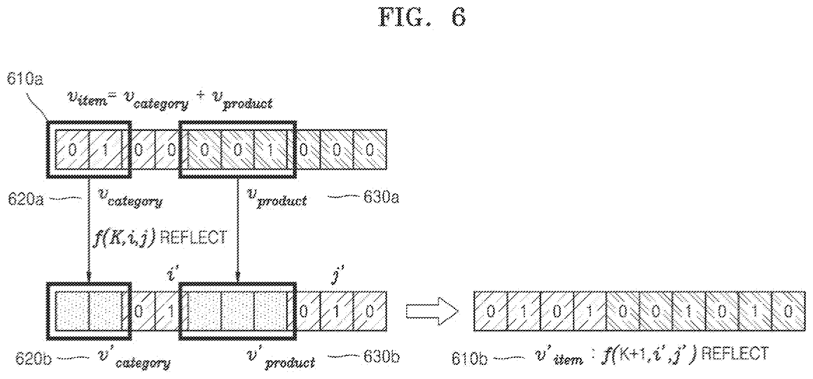

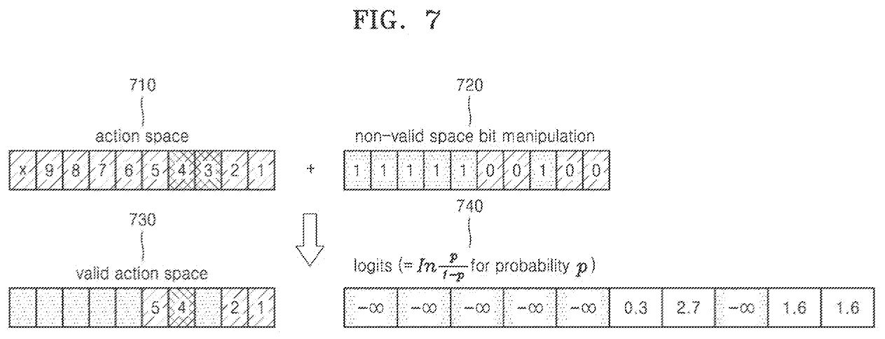

When the user's suitability for the obtained product combination is equal to or greater than a preset value, the product combination and discount rate inference model 150 may infer a discount rate in a valid integer range for the product combination. Discount rate inference may be performed by considering a margin for each product combination, the user's preference, and restrictions on the campaign or promotion. An example method of inferring a product combination and a discount rate using reinforcement learning will be described below with reference to FIGS. 6 and 7.

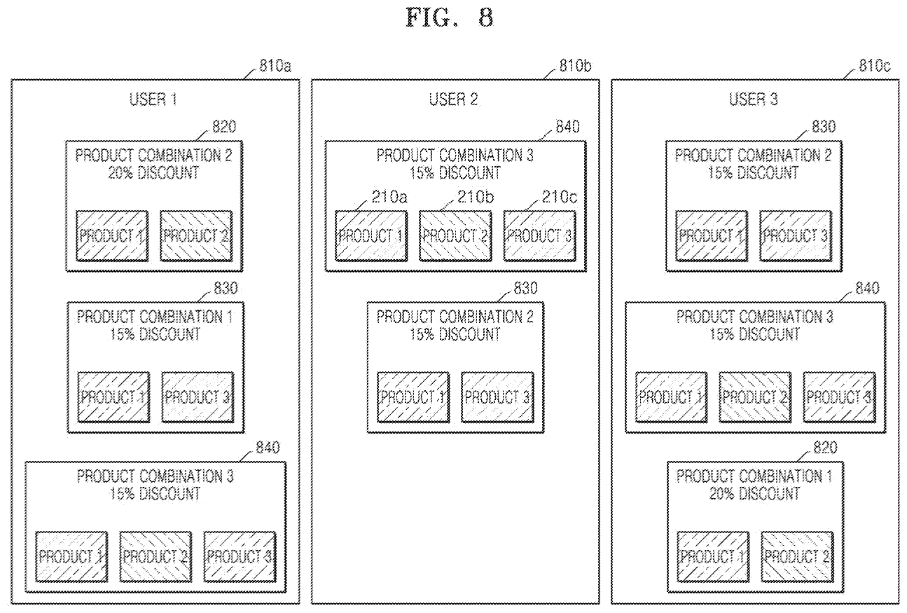

In an embodiment of the disclosure, the electronic device 10 may provide the promotion 160 including the product combination and the discount rate to the user. The electronic device 10 may provide the same information about a product combination and a discount rate to a plurality of users, but may change a display order by calculating a priority of a product combination included in a promotion for each user. The electronic device 10 may determine a priority by multiplying a user's suitability of a product combination by a logit value (decision-making reliability) of a discount rate to be applied to each product combination. The logit value may correspond to a logarithm of the odds of a probability p of a certain event occurring. A specific example will be described below with reference to FIG. 8.

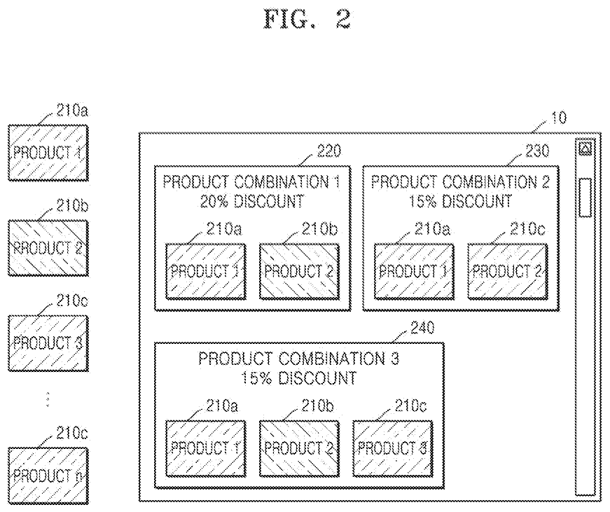

FIG. 2 is a diagram for describing an example of a promotion provided by an electronic device, according to an embodiment of the disclosure.

Referring to FIG. 2, the electronic device 10 may infer product combinations 220, 230, and 240 of a plurality of products 210a, 210b, 210c, and 210d and a discount rate and may provide the product combinations and the discount rate to a user.

In an embodiment of the disclosure, the electronic device 10 may obtain data related to at least one of the user, the plurality of products 210a, 210b, 210c, and 210d, or marketing.

In an embodiment of the disclosure, examples of the data related to the user may include, but are not limited to, the user's behavior information, location information using connected IP, channel information through which the user enters, accessed device information, and campaign information through which the user enters. In one or more examples, the data related to the user may include data generated while the user interacts using an online service. Examples of the data related to the plurality of products 210a, 210b, 210c, and 210d may include, but are not limited to, information of a product published to the user, a product group to which the product belongs, a name of the product, an ID of the product, and information about a price of the product. Examples of the data related to the marketing may include, but are not limited to, a type of a marketing campaign, statistics of sales, a duration of the marketing campaign, a discount rate according to the marketing, an ID of the campaign, information related to social media advertising, information related to an email marketing, or any other suitable marketing information known to one of ordinary skill in the art.

In one or more examples, the data obtained by the electronic device 10 may include information about a time for which the user maintains a page within a session and a time interval between pages.

In an embodiment of the disclosure, the electronic device 10 may determine the user's purchase intention based on the obtained data. A ‘user's purchase intention’ of the disclosure may refer to a user's purchase intention for all unspecified products rather than the user's purchase intention for a specific product. The electronic device 10 may identify the user's purchase intention by using an algorithm. In one or more examples, the electronic device 10 may identify the user's purchase intention by using an AI model. The AI model may output a likelihood of a user purchasing one or more products.

The electronic device 10 may extract and convert data for estimating the user's purchase intention from the obtained data. The electronic device 10 may infer the user's purchase intention by using the converted data as an input to the AI model. For example, the electronic device 10 may infer that the user's purchase intention exists when the user puts a product in a shopping cart, when the user adds a product as a product of interest, or when the number of times a specific product is viewed is equal to or greater than a certain number of times.

The electronic device 10 may output ‘1’ (or ‘0’) as an output value when the user's purchase intention exists, and may output ‘0’ (or ‘1’) as an output value when the user's purchase intention does not exist. The electronic device 10 may infer the user's purchase intention until a certain number of input and output values are obtained.

In an embodiment of the disclosure, when the user's purchase intention exists, the electronic device 10 may obtain the product combinations 220, 230, and 240 including two or more products and a discount rate of each product combination by applying the obtained data to an AI model. The AI model used to identify the product combination and the discount rate may be different from the AI model for estimating the user's purchase intention in order to increase sample efficiency. For example, learning efficiency may be improved by providing a promotion by inferring a product combination and a discount rate only for data of a user having a purchase intention.

In an embodiment of the disclosure, the electronic device 10 may obtain the product combinations 220, 230, and 240 including two or more products by using a reinforcement learning model for the plurality of products 210a, 210b, 210c, and 210d. Products included in a product combination may belong to different product groups.

For example, the electronic device 10 may infer the product combination 1 220 including the product 1 210a and the product 2 210b from among the plurality of products 210a, 210b, 210c, and 210d. In one or more examples, the electronic device 10 may infer the product combination 2 230 including the product 1 210a and the product 3 210c, and the product combination 3 240 including the product 1 210a, the product 2 210b, and the product 3 210c. The product 1 210a, the product 2 210b, and the product 3 210c belong to different product groups, and the electronic device 10 may identify a product combination based on the obtained data.

In an embodiment of the disclosure, the electronic device 10 may maintain a time complexity of an algorithm for inferring a product combination at O(n). For example, when a product combination including n products is identified, the electronic device 10 may maintain a complexity at O(n) by adding products included in a product combination one by one, starting from one product.

In an embodiment of the disclosure, the product combination and discount rate inference model 150 may identify a combination of products based on a relationship between different product groups. The relationship between product groups may be classified into a preference between a customer experience journey, a preference between product groups for each inflow channel or network, and a preference between product groups for each inflow digital marketing campaign.

In an embodiment of the disclosure, the electronic device 10 may identify a discount rate of each of the product combinations 220, 230, and 240 when the user's suitability for each of the identified product combinations 220, 230, and 240 is equal to or greater than a preset value. In one or more examples the user's suitability for an identified product combination may be a likelihood that the user will purchase the product combination. In an embodiment of the disclosure, the electronic device 10 may identify a discount rate of a product combination, by using the product combination as an input value to a hidden layer of the AI model. The hidden layer may be a layer between an input layer and an output layer of the AI model. The electronic device 10 may identify a discount rate in a valid integer range by considering a margin of each product combination, the user's preference, and restrictions on a campaign or a promotion by using the reinforcement learning model. For example, considering a margin of the product 1 210a, when a discount rate exceeding 20% is not valid, a discount rate of each of the product combinations 220, 230, and 240 including the product 1 210a may not exceed 20%. In one or more examples, considering a flagship of the product 3 210c, when a discount rate exceeding 15% is not valid, a discount rate of each of the product combinations 230 and 240 including the product 3 210c may not exceed 15%.

The electronic device 10 may provide the same information about an obtained product combination and discount rate to a plurality of users, but may change a display order of the product combination and the discount rate according to each user's preference. In one or more examples, when the user's preference for a specific product is equal to or less than a preset value, the electronic device 10 may not provide promotion information including the specific product. A specific example of providing promotion information will be described below with reference to FIG. 8.

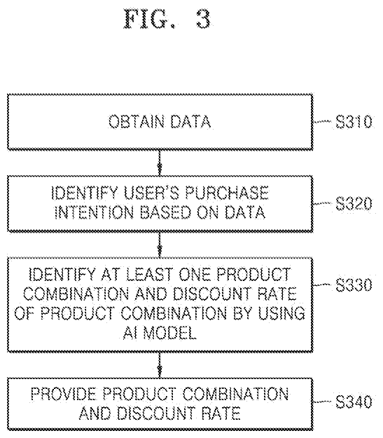

FIG. 3 is a flowchart for describing a method by which an electronic device provides a promotion, according to an embodiment of the disclosure.

In operation S310, the electronic device 10 may obtain data. In an embodiment of the disclosure, the data may refer to data related to at least one of a user, a product, or one or more marketing activities. The data may refer to data obtained by the electronic device 10 from an intranet or an online service interacting with the user.

Examples of the data related to the user may include the user's behavior data, location information using connected IP (e.g., location obtained through location or tracking services of a user's electronic device), channel information (e.g., website, social media) accessed by the user, accessed device information, and campaign information accessed by the user. In one or more examples, the data related to the user may include data generated while the user interacts using the online service. Examples of the data related to the product may include, but are not limited to, information about the product published to the user, a product group to which the product belongs, a name of the product, an ID of the product, and information about a price of the product. Examples of the data related to the marketing may include, but are not limited to, a type of a campaign, statistics of sales from the marketing or the campaign, a duration of the marketing, a discount rate according to the marketing, an ID of the campaign, information related to social media advertising, and information related to an email marketing. In one or more examples, the data obtained by the electronic device 10 may include a time for which the user maintains a page within a session and a time interval between pages.

In an embodiment of the disclosure, the electronic device 10 may perform preprocessing on the obtained data. The electronic device 10 may convert the obtained data into a one-dimensional vector or integer value to generate one one-dimensional vector. The preprocessing of the data may enable effective learning using high-level training data by converting the data into data that may be understood by an AI model or improving the quality of the data. In one or more examples, for data such as letters and words, the size of a word set may be converted into the dimension of a vector by using a one-hot encoding vector. For image data, components may be classified according to pixels, the size of an image may be normalized, and a convolutional feature map may be generated and finally used as a one-dimensional vector. The electronic device 10 may generate a one-dimensional vector through preprocessing on the obtained data, may perform a normalization operation on each of elements, and may use a result as an input to an AI model.

In an embodiment of the disclosure, the electronic device 10 may perform preprocessing by classifying element types of data. For example, the electronic device 10 may classify behavior data, such as click, scroll, add to a shopping cart, and payment which are events occurring while the user uses an online service, according to types. In one or more examples, the electronic device 10 may perform classification according to URLs of web pages or classification according to viewed products.

In operation S320, the electronic device 10 may identify the user's purchase intention based on the data. The electronic device 10 may identify the user's purchase intention through an algorithm by using the data obtained in operation S310. In one or more embodiments of the disclosure, the electronic device 10 may identify the user's purchase intention by using an AI model. A ‘user's purchase intention’ of the disclosure may refer to a user's purchase intention for all unspecified products rather than the user's purchase intention for a specific product.

In an embodiment of the disclosure, the electronic device 10 may extract and convert data for identifying the user's purchase intention. The electronic device 10 may set a criterion for identifying the user's purchase intention, may classify data according to the set criterion, and may use a result as an input to the algorithm. For example, the criterion used by the electronic device 10 to identify the user's purchase intention may include, but is not limited to, the user's online service usage or frequency of use, a user behavior pattern based on the user's interests, whether the user has viewed a promotion or a benefit, or a user behavior pattern associated with a product purchase process. A user's behavior pattern may correspond to a frequency of purchase of one or more items, an amount spent on products belonging to a particular category during a predetermined amount of time, a number of time a product is viewed during the predetermined time, etc. A specific example will be described below with reference to FIG. 5.

In an embodiment of the disclosure, the electronic device may use a deep neural network-based classification inference model in order to identify the user's purchase intention. The input to the AI model may include data related to the plurality of online users, the product, or the one or more marketing activities, or the preprocessed data.

The electronic device 10 may output ‘1’ (or ‘0’) as an output value when it is identified that the user's purchase intention exists, and may output ‘0’ (or ‘1’) as an output value when it is identified that the user's purchase intention does not exist. The electronic device 10 may infer the user's purchase intention until a certain number of input and output values are obtained.

In operation S330, the electronic device 10 may identify at least one product combination and a discount rate of the product combination by using an AI model. In an embodiment of the disclosure, the electronic device 10 may identify a product combination and a discount rate of the product combination through an AI model when it is identified that the user's purchase intention exists. The electronic device 10 may identify a discount rate of a product combination by using the product combination as an input value of a hidden layer of the AI model. The electronic device 10 may identify a product combination through the AI model when it is identified that the user's purchase intention exists and the user has viewed products belonging to two or more product groups.

The AI model for identifying a product combination and a discount rate may operate independently of the algorithm for identifying the user's purchase intention. Because the AI model for identifying a product combination and a discount rate operates only for a user having a product purchase intention, sample efficiency for training a model may be improved and a training time may be reduced. The electronic device 10 may infer a product combination by using a recurrent variational autoencoder (VAE) and reinforcement learning model. An example method will be described below with reference to FIG. 6.

In an embodiment of the disclosure, the electronic device 10 may calculate a preferred product group, product, and preferred model for each user by using an AI model. A product combination may include two or more products, and may include products belonging to different product groups. The electronic device 10 may obtain a product combination by reflecting the user's feedback according to a discount rate of the product combination.

In an embodiment of the disclosure, the electronic device 10 may classify a relationship between different product groups into a preference between product groups according to a customer experience journey, a preference between product groups for each inflow channel or network, and a preference between product groups for each inflow digital marketing campaign. The electronic device 10 may infer a combination of products suitable for a user feature distribution based on the classified relationship between product groups. For example, the electronic device 10 may detect a change in the user's preference in real time based on the classified preference information and may perform learning according to the preference.

In an embodiment of the disclosure, the electronic device 10 may sequentially identify products included in the product combination one by one. For example, in a state where one product is included, the electronic device 10 may add one product to form a combination including two products. Next, the electronic device 10 may sequentially obtain product combinations by adding one product to the product combination including two products to form a combination including three products. As the electronic device 10 sequentially identifies products included in the product combination, the electronic device 10 may maintain a complexity of an algorithm at O(n). The electronic device 10 may repeatedly perform an operation of identifying a product until there is no product satisfying a preset criterion or until a preset number of products is satisfied.

The electronic device 10 may exclude a product of the same category as products included in the product combination from candidates. In one or more examples, the electronic device 10 may calculate a score (e.g., a logit score) of each product combination, may arrange scores, and may infer a discount rate of each product combination. An example method by which the electronic device 10 infers a product combination will be described below with reference to FIG. 6.

In an embodiment of the disclosure, inference of a product combination and inference of a discount rate may be performed by the same AI model so that weight values of a deep neural network interact with each other. With respect to obtained product combinations, the electronic device 10 may obtain discount rates of product combinations in the order of scores of the product combinations. Identification of a product combination and identification of a discount rate of the product combination may be performed by the same AI model. As the same AI model operates, both a feedback on a product combination and a feedback on a discount rate may be reflected and then a product combination and a discount rate may be identified.

In an embodiment of the disclosure, the electronic device 10 may identify a discount rate of a product combination whose user suitability is equal to or greater than a preset value from among the identified product combinations.

In an embodiment of the disclosure, the electronic device 10 may calculate a discount rate of each combination by using a reinforcement learning model for inferring a discount rate. When calculating a discount rate, the AI model may be trained about a discount rate in a valid integer range using backpropagation based on a margin of each product combination, the user's preference, and restrictions on a campaign or a promotion. In detail, the electronic device 10 may infer a discount rate by considering a flagship product or a margin of a product combination calculated considering the cost of each of a plurality of products included in the product combination.

The electronic device 10 may obtain a discount rate in a valid integer range by using an action space in reinforcement learning. An example method of identifying a discount rate will be described below with reference to FIG. 7.

In operation S340, the electronic device 10 may provide the obtained product combination and the obtained discount rate. The electronic device 10 may provide to the user in the order of promotion product combinations with valid discount rates.

In an embodiment of the disclosure, the electronic device 10 may provide the same information about a product combination and a discount rate to the plurality of users, but may change a display order of the product combination and the discount rate according to each user's preference. For example, the electronic device 10 may preferentially provide promotion information about a product combination including a product A to a user with a high interest in the product A over other product combinations. A specific example in which the user is provided a promotion will be described below with reference to FIG. 8.

The electronic device 10 may provide information about the product combination and the discount rate until a promotion period continues, and then when the promotion is updated, may provide information about an updated product combination and discount rate.

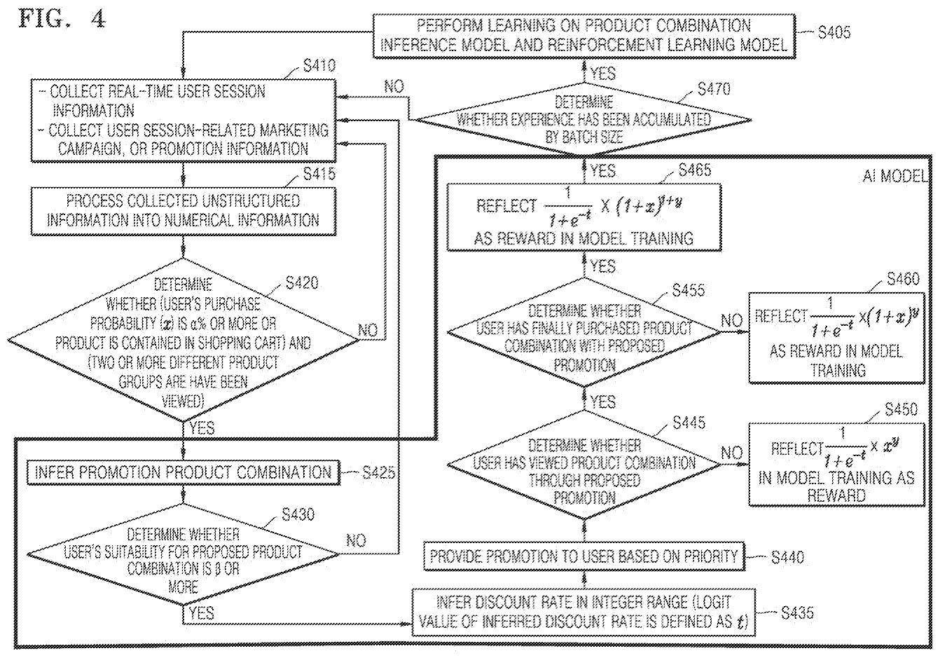

The electronic device 10 may train a reinforcement learning model by reflecting feedback information of the user on the promotion information provided to the user by using a reward function. A process of training a reinforcement learning model using a reward function will be described with reference to FIG. 4.

FIG. 4 is a flowchart for describing a method by which an electronic device provides a promotion by using reinforcement learning, according to one or more embodiments of the disclosure. Hereinafter, the same description as that made with reference to FIG. 3 will be omitted for the brief description of the specification.

In operation S405, the electronic device 10 may perform learning on a product combination inference model and a reinforcement learning model. The learning may be performed through an AI model as described below in detail.

In operation S410, the electronic device 10 may obtain data through an intranet or an online service with which a user interacts. For example, the electronic device 10 may collect real-time user session information, user session-related marketing campaign, or promotion information. The real-time user session information may include, but is not limited to, a website visited by the user, a product viewed by the user, a time spent on each visited web page, location information based on connected IP, information about an accessed device, or channel information through which the user enters.

The electronic device 10 may use the obtained data as an input value to an algorithm.

In operation S415, the electronic device 10 may process collected unstructured information into numerical information. The electronic device may perform preprocessing on the obtained data. The preprocessing of the data may enable effective learning using high-level training data by converting the data into data that may be understood by the electronic device or improving the quality of the data. In an embodiment of the disclosure, the electronic device 10 may identify the user's purchase intention by using an AI model. The electronic device may enable effective learning by preprocessing the data into data that may understood by the AI model. For example, the electronic device may convert or normalize the data into data in a suitable form as an input value to the AI model and use the data. In an embodiment of the disclosure, the electronic device 10 may perform preprocessing by classifying the data according to types.

In operation S420, the electronic device 10 may identify the user's purchase intention based on a preset criterion. For example, the electronic device may identify that the user's purchase intention exists when the user's purchase probability (x %) calculated by the electronic device 10 is α % or more or when a product is contained in a shopping cart.

In an embodiment of the disclosure, the electronic device 10 may set a criterion for identifying the user's purchase intention, may classify the data according to the set criterion, and may use a result as an input value to an algorithm. A specific example will be described below with reference to FIG. 5.

In an embodiment of the disclosure, the electronic device 10 may identify the user's purchase intention by using an AI model. The AI model may be a deep neural network-based classification inference model using the obtained data as an input value. The electronic device 10 may output ‘1’ (or ‘0’) as an output value when the user's purchase intention exists, and may output ‘0’ (or ‘1’) as an output value when the user's purchase intention does not exist. The electronic device 10 may infer the user's purchase intention until a certain number of input and output values are obtained.

In an embodiment of the disclosure, in the case that the electronic device 10 identifies that the user's purchase intention exists, when the user has viewed two or more different product groups, the electronic device 10 may identify a product combination and a discount rate through an AI model. When the electronic device 10 identifies that there is no user's purchase intention or the user has viewed only products belonging to the same product group, the electronic device 10 may not perform learning on the AI model for learning efficiency and may perform operation S410 in which user or marketing campaign information is collected.

In operation S425, the electronic device 10 may infer a promotion product combination. When the electronic device 10 identifies that the user's purchase intention exists and the user has viewed products included in two or more different product groups, the electronic device 10 may infer a product combination including two or more products belonging to different product groups by using an AI model.

The AI model for identifying a product combination may operate independently of the algorithm or the AI model for identifying the user's purchase intention. This independence advantageously increases sample efficiency for learning and reduce a training time by training the AI model for identifying a product combination and a discount rate only for a user having a product purchase intention. The electronic device may infer a product combination by using an AI model using a recurrent VAE and reinforcement learning model. An example method will be described below with reference to FIG. 6.

In an embodiment of the disclosure, the electronic device 10 may maintain the number of nodes for inferring a product combination at O(n). For example, the electronic device 10 may maintain a time complexity of an algorithm at n by gradually increasing the number of products included in a product combination. For example, when one product is included in a product combination, the electronic device may perform an operation of identifying one additional product to include two products, and then identifying another product to include three products. The electronic device 10 may repeatedly perform an operation of identifying products until there is no product satisfying a set criterion or until a preset number of products is satisfied.

In an embodiment of the disclosure, the electronic device 10 may classify a relationship between different product groups into a preference between product groups according to a customer experience journey, a preference between product groups for each inflow channel or network, and a preference between product groups for each inflow digital marketing campaign. The electronic device 10 may infer a combination of products suitable for a user feature distribution based on the classified relationship between product groups. For example, the electronic device 10 may detect a change in the user's preference in real time based on the classified preference information and may perform learning according to the preference.

In an embodiment of the disclosure, the electronic device 10 may obtain the user's feedback on a product combination and a discount rate through a reward function by using a model using reinforcement learning. The electronic device 10 may identify a product combination based on the obtained feedback or a reward value.

In operation S430, the electronic device 10 may identify whether the user's suitability y for the obtained product combination is equal to or greater than a preset value. When the user's suitability for the proposed product combination is less than B, the electronic device 10 may not infer a discount rate of the product, and may perform operation S410 in which information about a user and information about a marketing campaign and a promotion associated with the user are collected.

In an embodiment of the disclosure, the electronic device 10 may calculate the user's suitability for the obtained product combination based on the obtained data. For example, the electronic device 10 may calculate the user's interest in a product included in the obtained product combination, based on the number of times the product has been viewed by the user, whether the product has been added to a shopping cart, and whether there is a payment history for the product. The electronic device 10 may obtain the user's suitability y for the product combination based on the user's interest in the product included in the product combination and may compare the user's suitability with a preset value.

In operation S435, the electronic device 10 may infer a discount rate in an integer range for the obtained product combination. When the user's suitability for the product combination obtained in operation S425 is equal to or greater than a preset value, the electronic device 10 may infer a discount rate of the product combination by using an AI model. Because the electronic device 10 infers a product combination and a discount rate of the product combination by using the same model, weight values of a deep neural network may interact.

In an embodiment of the disclosure, to infer a discount rate, the electronic device 10 may identify a discount rate in a valid range by considering a margin of the product combination, the user's preference, and restrictions on a campaign or a promotion through reinforcement learning. For example, the electronic device 10 may infer a discount rate by considering a margin considering the cost of a plurality of products included in the product combination and whether each product is a flagship product.

In an embodiment of the disclosure, the electronic device 10 may obtain the user's feedback on a product combination and a discount rate through a reward function by using a model using reinforcement learning. The electronic device 10 may identify a discount rate of the product combination by reflecting the obtained feedback or reward value.

The electronic device 10 may obtain a discount rate in a valid integer range by using an action space in reinforcement learning. An example method will be described below with reference to FIG. 7.

A logit value of the discount rate inferred by the electronic device 10 for the product combination is defined as ‘t’. The logit value for the discount rate is a value indicating a degree to which a high reward is expected, and may refer to decision-making reliability. The electronic device may calculate a priority of each promotion by using ‘t’, may set a reward function, and may perform reinforcement learning by reflecting an obtained reward value in a model.

In operation S440, the electronic device 10 may provide a promotion according to a priority to the user. The promotion may include the promotion combination and the discount rate corresponding to the product combination respectively obtained in operations S425 and S435. The priority may be calculated by multiplying the user's suitability for the product combination by the decision-making reliability derived when inferring the discount rate. The electronic device 10 may provide the promotion to the user by performing personalization for each session based on the calculated priority.

In an embodiment of the disclosure, the priority for the promotion may be calculated according to Equation 1.

$$\frac{1}{1 + {e}^{- t}} {X ( 1 + x )}^{1 + y} \qquad Equation ( 1 )$$

In Equation 1, ‘x’ denotes the user's purchase probability, ‘y’ denotes the user's suitability for the product combination, and ‘t’ denotes the logit value of the discount rate inferred for the product combination. In Equation 1, as the user's purchase probability increases, a value of (1+x) increases with a value of 1 or more, and as the user's suitability for the product combination increases, a value of (1+y) increases with a value of 1 or more and the priority increases. Also, it is found that as a value of ‘t’ indicating a degree to which a high reward for the discount rate is expected increases, a value closer to 1 is obtained and the priority increases.

In an embodiment of the disclosure, the electronic device 10 may provide promotions in the order of high priority values according to Equation 1 to users. For example, the electronic device 10 may provide the same information about a product combination and a discount rate to a plurality of users, but may change a display order of the product combination and the discount rate according to a priority of each user. Also, the electronic device may not display some product combinations included in a promotion according to a user's priority. For example, the electronic device may preferentially provide promotion information about a product combination including a product A to a user having a high interest in the product A over other product combinations. In one or more examples, when a user's suitability for a product combination B is equal to or less than a preset value, the electronic device may not provide promotion information about the product combination B to the user.

In operation S445, the electronic device 10 may identify whether the user has viewed the product combination through the proposed promotion. The electronic device 10 may reflect the user's feedback on the promotion through a reward function according to whether the product has been viewed through the promotion.

When the user has not viewed the product through the proposed promotion, in operation S450, the electronic device 10 may reflect a reward value in Equation 2 in model training.

$$\frac{1}{1 + {e}^{- t}} {X ( x )}^{y} \qquad Equation 2$$

Variables in Equation 2 are the same as those in Equation 1. As the user has not viewed the product through the promotion, a reward value may be less than 1. In one or more examples, as a value of t increases, a value of

$$\frac{1}{1 + {e}^{- t}}$$

is closer to 1 but is less than 1. Also, as x is the user's purchase probability and has a value less than 1, a reward value obtained in Equation 2 is less than 1. For example, when the user has not viewed the product combination through the promotion, it corresponds to a negative feedback on the promotion, and thus, a reward value less than 1 is reflected as a reward of reinforcement learning.

When the user has viewed the product combination through the proposed promotion, in operation S455, the electronic device 10 may identify whether the user has finally purchased the product combination with the proposed promotion. A reward value reflected in model training may be differently calculated according to whether the user has finally purchased the product combination through the proposed promotion. When the user has not finally purchased the product combination through the promotion, in operation S460, the electronic device may calculate a reward value in Equation 3 and reflect the reward value as a reward of a reinforcement learning model, and when the user has finally purchased the product combination through the promotion, in operation S465, the electronic device may calculate a reward value in Equation 4 and reflect the reward value as a reward of a reinforcement learning model.

$$\frac{1}{1 + {e}^{- t}} {X ( 1 + x )}^{y} \qquad Equation 3$$

$$\frac{1}{1 + {e}^{- t}} {X ( 1 + x )}^{1 + y} \qquad Equation 4$$

Variables in Equation 3 and Equation 4 may be the same as those in Equation 1. As the user views the product combination through the promotion, exponential functions in Equation 3 and Equation 4 have the same base (1+x) but different exponents (y and (1+y) respectively). Assuming that values of exponents are different and variables are the same, it is found that a reward value obtained through Equation 4 is greater than that obtained through Equation 3. For example, when the product combination has been finally purchased through the promotion, a greater reward value is reflected in reinforcement learning.

A reward value obtained through operations S450, S460, and S465 may be reflected in model training, and in operation S470, the electronic device 10 may identify whether experience has been accumulated by a batch size. When sufficient experience has been accumulated, the electronic device 10 may perform model training according to operation S405, and when experience is insufficient compared to a batch size, the electronic device 10 may repeatedly perform operations starting from operation S410 of collecting user and user session-related promotion and campaign information until experience has been accumulated by a batch size.

FIG. 5 is a diagram for describing an example of data obtained through an interaction between a user and an online service, according to an embodiment of the disclosure.

Referring to FIG. 5, in order to identify a user's purchase intention, the electronic device 10 may perform preprocessing by classifying element types of obtained data and may use a preprocessing result as an input value.

In an embodiment of the disclosure, the electronic device 10 may classify an element type of obtained data and may perform preprocessing. The electronic device 10 may classify behavior data, such as click, scroll, add to a shopping cart, and payment which are events occurring while a user uses an online service, according to types. The electronic device 10 may perform preprocessing on the classified data, may set a reference score of each data, and may identify the user's purchase intention.

When the user enters by clicking (510) a preorder event button, the electronic device 10 may obtain the user's inflow path and a URL of a web page. In one or more examples, whether the user enters (520) by clicking (510) the preorder button and the user clicks (530) a purchase button may be used as data for identifying the user's purchase intention. In one or more examples, the user's inflow path may correspond to a series of interaction with a web page (e.g., clicks on links, selection of options, etc.).

The user may select (540) a model option to be purchased in a purchase page. The model option selected by the user is data related to a product and may include, but is not limited to, information about a product group to which the product belongs, an ID of the product, and a price of the product. In one or more examples, a case where the user clicks various products to select a model option or a time (550) for which the user stays on a corresponding page to select a product may be used as data for identifying the user's purchase intention, data for determining the user's suitability for a product combination, or data for identifying a valid discount rate.

The user may select (560) a color for the selected model and may select (570) a payment method. For example, when the user selects a card or Samsung Pay, the electronic device 10 may additionally provide benefit information according to a card type or benefit information according to Samsung Pay when providing a promotion.

When the user repeats (580) the same purchase pattern, data indicating that an error has occurred in the corresponding page may be obtained, and when the user clicks (590) a final purchase, a final purchase history may be used as data for identifying the user's purchase intention or data for determining the user's suitability for the product combination. Thus, as illustrated in FIG. 5, a history of the user's interaction with a display of a product on a product page is captured.

FIG. 6 is a diagram for describing a method of inferring a product combination, according to an embodiment of the disclosure.

Referring to FIG. 6, a method of inferring a product combination including K+1 products by adding one product to a product combination including K products is illustrated.

In an embodiment of the disclosure, the electronic device 10 may maintain the number of nodes for inferring a product combination at O(n). For example, the electronic device 10 may maintain a time complexity of an algorithm at n by gradually increasing the number of products included in a product combination. In detail, when a product combination including k products from among n products is constructed, a time complexity of 0(n²) is required, whereas when a product complexity is inferred by adding one product to a product combination including K products, a time complexity may be maintained at n.

In an embodiment of the disclosure, the electronic device 10 may classify a relationship between different product groups (categories) into a preference between product groups according to a customer experience journey, a preference between product groups for each inflow channel or network, and a preference between product groups for each inflow digital marketing campaign. The electronic device 10 may infer a combination of products based on the classified relationship between product groups.

Hereinafter, f(K, i, j) denotes a product combination having a highest user suitability when a product group (category) index of a last added product from among combinations including K products is i and a product index is j. A vector Vᵢₜₑₘ 610a of a combination including K products may include vectors related to a product group 620a and a product 630a. For example, Vᵢₜₑₘ 610a has a value of 0100 for the product group 620a and has a value of 001000 for the product 630a.

The electronic device 10 may infer V′ᵢₜₑₘ 610b obtained by adding one product to the vector Vᵢₜₑₘ 610a based on obtained data, by using a reinforcement learning model for product combination inference. A product added to a product combination may belong to a product group (category) different from products included in the existing product combination, and may be identified by excluding products with indices equal to or less than a product index of a last product.

In detail, identification of a product combination may be performed by using an action space. Hereinafter, an action space in the disclosure may refer to a set of all possible actions in a given environment. In an embodiment of the disclosure, a (K+1)^{th} product may include a product belonging to a product group different from a K^{th} product. For example, the electronic device 10 may exclude products of the same product group as the K^{th} product from an action space. In an embodiment of the disclosure, a product index of the (K+1)^{th} product may be greater than a product index of the K^{th} product. That is, the electronic device 10 may exclude products with product indices equal to or less than a product index of the K^{th} product from the action space.

For example, in the case of Vᵢₜₑₘ 610a, the electronic device 10 may obtain V′_{category} 620b by reflecting f(K,i,j) and excluding items of the same category as V_{category} 620a that is a category of a K^{th} product from an action space. Also, the electronic device 10 may obtain V″ product 630b by reflecting f(K, i, j) and excluding products with indices equal to or less than V_{product} 630a that is a product index of the K^{th} product from the action space. In the action space, the electronic device 10 may determine a (K+1)^{th} product through f(K, i, j) and may obtain V′ᵢₜₑₘ 610b.

In an embodiment of the disclosure, the electronic device 10 may perform product combination inference recursively until there is no valid product in an action space or a preset number of products included in a product combination is satisfied.

Hereinafter, an example operation method of an algorithm will be described with reference to FIG. 7.

FIG. 7 is a diagram for describing an inference process in a reinforcement learning algorithm, according to an embodiment of the disclosure. In detail, an inference process in an algorithm for increasing the efficiency of neural network training in a discrete action space is illustrated.

Referring to FIG. 7, the electronic device 10 may select a valid action space by using an action space 710 and bit manipulation 720 in reinforcement learning.

In one or more examples, bit manipulation refers to an act of algorithmically manipulating bits or pieces of data shorter than a word. Bit manipulation may eliminate or reduce the need to repeat a structure of data and may manipulate data at a high speed.

In an embodiment of the disclosure, when the electronic device 10 identifies a product combination or identifies a discount rate of the product combination, the electronic device 10 may use an action space. In detail, when the electronic device 10 identifies one product to be added to a product combination including K products, a (K+1)^{th} product may belong to a product group different from products included in the product combination and may have a greater product index than a K^{th} product. In order to identify the (K+1)^{th} product satisfying the condition, the electronic device 10 may identify valid products by using the action space.

In one or more examples, when the electronic device 10 identifies a discount rate in a valid range for a product combination, the electronic device 10 may exclude discount rates in an invalid range from the action space through bit manipulation. For example, for a total of 101 discount rates in a valid integer range including 0% to 100%, the electronic device 10 may calculate a range of possible discount rates according to product combinations and may exclude impossible action spaces from a learning range.

An existing method of, when an impossible action space is selected, reducing a probability of selecting a corresponding node by adding a negative reward value causes learning inefficiency because the probabilistically impossible node itself may be selected. Accordingly, in an embodiment of the disclosure, a logit value (decision-making reliability) of an invalid node may be set to negative infinity, thereby blocking the propagation of the value in a neural network.

Among reinforcement learning algorithms, a value function-based reinforcement learning algorithm is an algorithm that makes decisions based on value. That is, an optimal Q function may be obtained by learning a Q function and decision making may be performed based on the optimal Q function. In a value function-based reinforcement learning algorithm, values set to negative infinity have a zero (0) probability of being selected, and thus, may be excluded from model inference and training.

In one or more examples, among reinforcement learning algorithms, a policy function-based reinforcement learning algorithm does not use a value function in decision making unlike value-based reinforcement learning, but instead directly learns a policy and makes decisions by using the learned policy. In policy function-based reinforcement learning, an objective function is set, and an optimal policy is set so that an objective function has a higher value. Accordingly, reinforcement learning may be performed so that the objective function increases. In a policy function-based algorithm, an action is determined according to an action-probability distribution function (π_{θ}(α|s)). Accordingly, outputting a probability as 0 for an action in which a probability distribution is not valid is a necessary and sufficient condition. To convert a logit value into a probability value, a softmax function of Equation 5 may be used.

$$softmax ( {x}_{i} ) = \frac{{e}^{{x}_{i}}}{{\sum }_{k = 1}^{K} {e}^{{z}_{k}}} for i = 1 , … , K and x = ( {x}_{1} , … {x}_{K} ) ∈ {ℝ}^{K}$$

In Equation 5, when a value of xᵢ has negative infinity (−∞), e^{x}^{ᵢ} converges to 0, and thus, invalid actions may be excluded from model inference and training.

FIG. 8 is a diagram for describing an example of providing a promotion according to a user's priority, according to an embodiment of the disclosure.

Referring to FIG. 8, it is found that the order of displaying a plurality of product combinations 820, 830, and 840 varies according to a plurality of users 810a, 810b, and 810c.

For a plurality of products, the electronic device 10 may identify the product combinations 820, 830, and 840 and a discount rate of each product combination by using an AI model using reinforcement learning. The electronic device may infer a product combination including a plurality of products based on data obtained from an intranet or an online service, and when a user's suitability for the product combination is equal to or greater than a preset value, may infer a valid discount rate of the product combination.

The electronic device 10 may, for promotion information including a product combination and a discount rate, calculate a priority value of each product combination based on a user's product purchase probability, the user' suitability for the product combination, and a logit value (decision-making reliability) of a discount rate. The electronic device 10 may provide the same product combination and discount rate information to a plurality of users, but may change a display order of the product combination according to an obtained priority value. In one or more examples, in an embodiment of the disclosure, when a user's priority value of a specific product combination is equal to or less than a preset value, the electronic device 10 may not provide the product combination.

For example, the electronic device 10 may provide all of the inferred product combination 1 820, the product combination 2 830, and the product combination 3 840 to the user 1 810a. In one or more examples, when priority values are high in the order of the product combination 1 820, the product combination 2 830, and the product combination 3 840, the electronic device 10 may display the product combinations in an ascending order of priority. For the user 2 810b, because a priority value of the product combination 1 820 from among the inferred product combinations is equal to or less than a preset value, information about the product combination may not be provided to the user 2 810b. For the user 3 810c, when an interest of the user 3 810c in the product combination 3 from among the product combinations 1, 2, and 3 is high and priority values of product combinations are high in the order of the product combination 2 830, the product combination 3 840, and the product combination 1 820, the electronic device 10 may display the product combinations in an ascending order of priority.

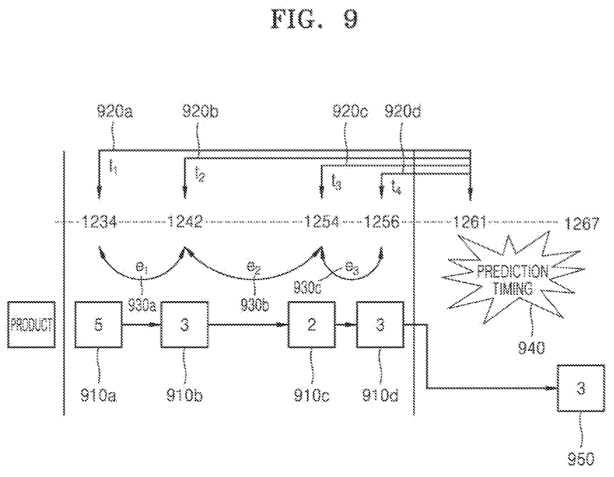

FIG. 9 is a diagram for describing time information included in data, according to an embodiment of the disclosure.

Referring to FIG. 9, when a user views a plurality of products 910a, 910b, 910c, and 910d over time, the electronic device 10 may obtain information about a time or timing.

In an embodiment of the disclosure, the electronic device 10 may obtain data from an intranet or an online service. The data may include data related to a user, a product, or marketing, and may include time information obtained as a result of an interaction between the user and the online service.

In an embodiment of the disclosure, the electronic device 10 may differently set a weight value for each data based on obtained time information. In detail, the data may include information about timings 920a, 920b, 920c, and 920d at which the user views a specific product. As a timing at which a specific product is viewed is farther from a prediction timing 940, a lower weight value may be set to an event in which the product is viewed. The prediction timing 940 may include a timing at which the user's purchase intention is identified, a timing at which a product combination is identified, a timing at which the user's suitability for the product combination is identified, or a timing at which a discount rate is identified.

For example, a low weight value may be set to information about the product 5 910a viewed at a time ti farthest from the prediction timing 940. A high weight value may be set to information about the product 3 910d viewed at a time closest to the prediction timing 940.

In an embodiment of the disclosure, the electronic device 10 may identify the user's preference for a specific product based on the obtained time information. In detail, the data may include information about times 930a, 930b, and 930c for which the user stays within a web page while viewing a specific product. It may be identified that as a time for which the user stays on a web page increases, the user's preference for a corresponding product increases.

For example, for the plurality of products 910a, 910b, 910c, and 910d viewed before the prediction timing 940, the electronic device 10 may identify that the user's preference for the product 3 910b is high based on information about e₂ 930b that is the time for which the user stays while viewing the product 3 910b from among the times for which the user stays on the page while viewing the products.

In an embodiment of the disclosure, the electronic device 10 may use the obtained time information as data for identifying the user's purchase intention, data for identifying a product combination, data for determining the user's suitability for the product combination, data for identifying a discount rate of the product combination, or data for providing a promotion. For example, when the electronic device identifies a product combination, the electronic device may set a high weight value to the product 3 910d viewed at the time t₄ 920d closest to the prediction timing 940 for predicting a product included in the product combination. Also, the electronic device may identify that the user's preference is high for the product 3 910b viewed for the time e₂ 930b that is the longest from among the products viewed before the prediction timing 950. Accordingly, the electronic device may identify the product 3 as a product to be included in the product combination.

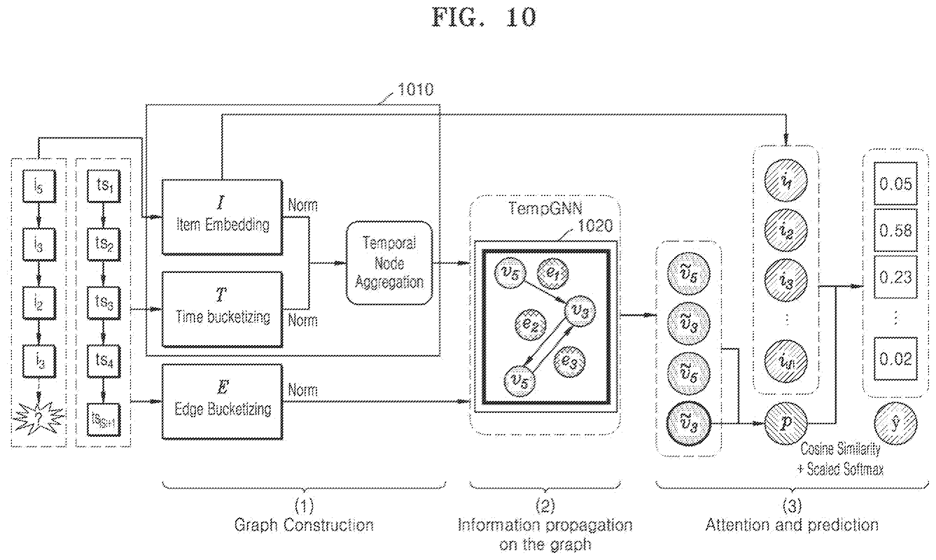

FIG. 10 is a diagram for describing a method of considering time information in an algorithm, according to an embodiment of the disclosure.

Referring to FIG. 10, in a method of training AI, two methods of applying additional data on time information are proposed.

In an embodiment of the disclosure, time information may include time information obtained as a result of an interaction between a user and an online service. In detail, time information may include, but is not limited to, a prediction timing, a timing at which an event occurs, a time for which the user stays within a specific session, and a time interval between pages. Hereinafter, a method of using time information in AI model training will be described.

A first method 1010 is a method of adding time information to information of a product itself. Information about a product may include, but is not limited to, information of a product published to a user, a product group to which the product belongs, an ID of the product, and information about a price of the product. In an embodiment of the disclosure, in a method of adding time information to information of a product itself, the time information may include, but is not limited to, information about a timing at which the product is viewed or a time for which the user stays within a page for viewing the product.

For example, the electronic device 10 may add information about how far a timing of viewing a product is from a prediction timing to the information of the product itself. In one or more examples, the electronic device 10 may add information about a time for which the user stays while viewing the product to the information of the product itself.

In an embodiment of the disclosure, the electronic device 10 may normalize information about a product and information about a time to generate one set. The electronic device 10 may divide an entire time into N groups. Based on the divided time, the electronic device 10 may reflect information about a time in product information.

In a second method 1020, the electronic device may consider time information when exchanging information in a graph neural network (GNN). In one or more examples, GNN in the disclosure is a graph neural network and may be used for training an AI model. The electronic device 10 may divide an entire time into N groups. The electronic device 10 may reflect information about a time in product information during GNN training. For example, when the electronic device identifies a product combination, for products viewed by the user, the electronic device may reflect a timing at which a product is viewed or a time for which the user stays on a page to view the product, and may exchange information between nodes respectively indicating products.

In an embodiment of the disclosure, the electronic device 10 may perform learning using the above two methods by reflecting time information, but the disclosure is not limited thereto. The electronic device 10 may identify a product combination or may identify a discount rate, based on a learning result.

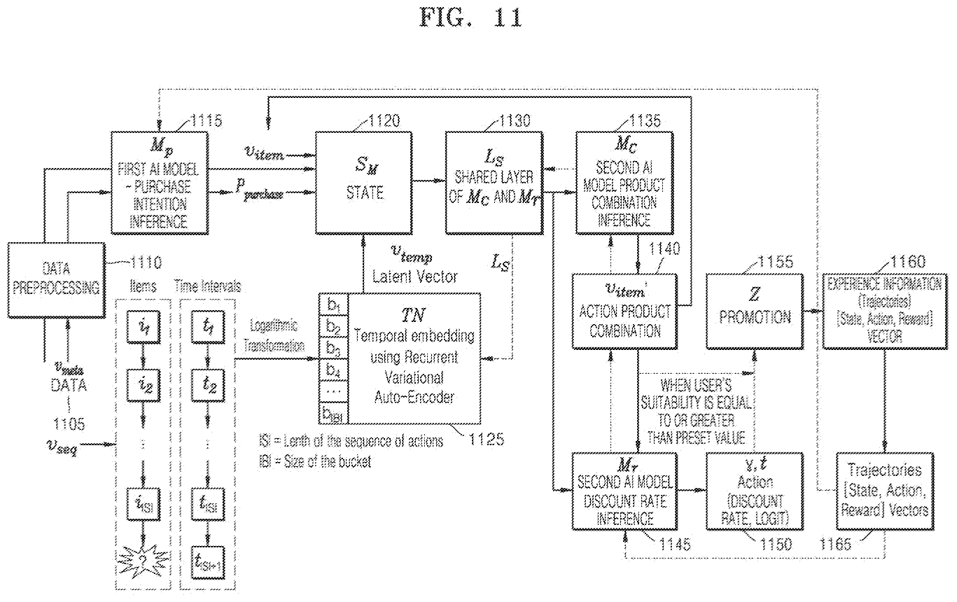

FIG. 11 is a diagram for describing an algorithm by which an electronic device provides a promotion, according to an embodiment of the disclosure.

Referring to FIG. 11, an entire process of identifying a user's purchase intention and identifying a product combination and a discount rate is illustrated. Hereinafter, the same description as that made above will be omitted for the brief description of the specification.

In an embodiment of the disclosure, the electronic device 10 may obtain data 1105 from an intranet or an online service with which a user interacts. The data may include, but is not limited to, information about the user, a product, one or more marketing activities, or a time corresponding to a user's activities.

The electronic device 10 may perform preprocessing 1110 on the obtained data to be suitable for an AI model. The preprocessing of the data may refer to processing unstructured information into numerical information. The electronic device 10 may enable effective learning using high-level training data by converting the data into data that may be understood by the AI model or improving the quality of the data.

The electronic device 10 may use the obtained data or the preprocessed data as an input value to the AI model. The electronic device 10 may identify the user's purchase intention through a user purchase intention inference model (Mₚ) 1115 based on the data. When it is identified that the user's purchase intention exists, the user purchase intention inference model 1115 may output ‘1’ (or ‘0’) as an output value (P_{purchase}), and when it is identified that there is no user's purchase intention, the user purchase intention inference model 1115 may output ‘0’ (or ‘1’) as an output value (P_{purchase}). The user purchase intention inference model (Mₚ) 1115 may infer the user's purchase intention until a certain number of input and output values are obtained.

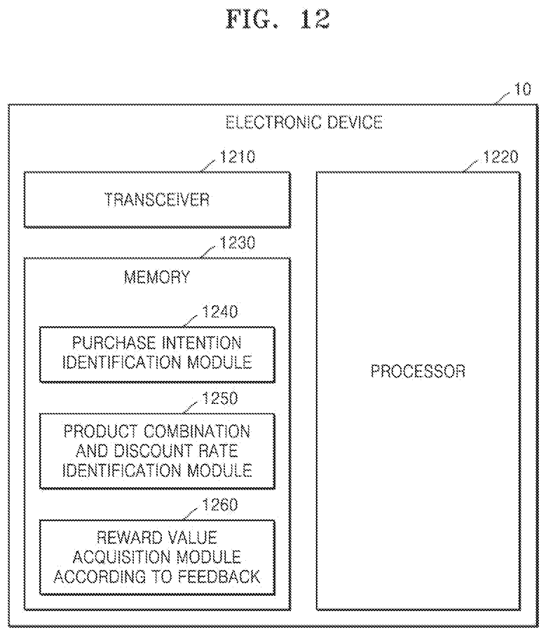

The electronic device 10 may update state information (S_{M}) 1120 through data (vₜₑₘₚ) 1125 obtained by adding time information to information about a product and the user's purchase intention. The data obtained by adding time information to product information has been described with reference to FIG. 12. In an embodiment of the disclosure, the electronic device 10 may recursively update a product combination (Vᵢₜₑₘ) including K products through the state information (S_{M}) 1120 until identification of the product combination is completed. The state information (S_{M}) 1120 may be transmitted to a shared layer (Lₛ) 1130 shared by a model for inferring a product combination and a discount rate. In an embodiment of the disclosure, the shared layer (Lₛ) 1130 may refer to a hidden layer. The electronic device 10 may form a neural network by continuously connecting an input layer and an output layer of the AI model by using the shared layer (Lₛ) 1130. Because inference of a product combination and inference of a discount rate are performed through the same AI model, the shared layer (Lₛ) 1130 may share a result value of each operation. When inferring a product combination and a discount rate through the shared layer (Lₛ) 1130, inference may be performed by allowing weight values of a deep neural network to interact with each other. Information of the shared layer (Lₛ) 1130 may be used as an input value to a model (M_{c}) 1135 for inferring a product combination.

In an embodiment of the disclosure, the model (M_{c}) 1135 for inferring a product combination may identify an updated product combination (vᵢₜₑₘ′) 1140 by identifying a (K+1)^{th} product to be added to the product combination. The updated product combination (Vᵢₜₑₘ′) 1140 may be transmitted to the state information (S_{M}) 1120, thereby recursively inferring a product combination. Also, when the user's suitability for the updated product combination (Vᵢₜₑₘ′) 1140 is equal to or greater than a preset value, the electronic device 10 may infer a discount rate of the product combination (Vᵢₜₑₘ′) 1140.

In an embodiment of the disclosure, a model (Mᵣ) 1145 for inferring a discount rate may infer a discount rate in a valid integer range for the product combination. The model (Mᵣ) 1145 for inferring a discount rate may identify a discount rate in a valid range by considering information about the product (e.g., a price of the product, a margin, and whether the product is a flagship product), the user's preference, and restrictions on a campaign or a promotion. The model (Mᵣ) 1145 for inferring a discount rate may identify a logit value ‘t’ 1150 that is decision-making reliability derived according to discount rate inference and the discount rate.

In an embodiment of the disclosure, the electronic device 10 may provide a promotion 1155 including the product combination and the discount rate. The electronic device 1155 may provide the same information about a product combination and a discount rate to a plurality of users, but may change a display order of the product combination and the discount rate according to each user's preference.

In an embodiment of the disclosure, the electronic device 10 may calculate a reward value 1160 according to the user's feedback on the provided promotion 1155. The electronic device 10 may calculate a different reward value according to whether the product combination has been viewed or whether the product combination has been purchased through the promotion 1155.

In an embodiment of the disclosure, the electronic device 10 may obtain experience information 1165 based on the state information (S_{M}) 1120, the product combination (Vᵢₜₑₘ′) 1140, the discount rate of the product combination, the logit value ‘t’ 1150 of the discount rate, and the reward value 1160 according to the user's feedback. The electronic device 10 may perform reinforcement learning by applying the experience information 1165 to the user purchase intention inference model (Mₚ) 1115, the shared layer (Lₛ) 1130, the model (M_{c}) 1135 for inferring a product combination, and the model (Mᵣ) 1145 for inferring a discount rate.

FIG. 12 is a schematic block diagram illustrating an electronic device, according to an embodiment of the disclosure.

Referring to FIG. 12, the electronic device 10 according to an embodiment of the disclosure may include a transceiver 1210 that communicates with an external device, at least one processor 1220 that executes at least one instruction, and a memory 1230 that stores at least one instruction. However, not all of the components shown in FIG. 12 are essential components. The electronic device 10 may include more or fewer components than those shown in FIG. 12.

The transceiver 1210 may communicate with external devices through a wired or wireless network. The external devices are devices capable of transmitting and receiving content through a channel, and may include a broadcasting station server, a content storage device, and a display device.

The transceiver 1210 according to an embodiment of the disclosure includes at least one of a short-range communication module, a wired communication module, a mobile communication model, or a broadcast receiving module. In one or more examples, at least one communication module refers to a communication module capable of performing data transmission/reception through a network that follows a communication standard such as a tuner for performing broadcast reception, Bluetooth, wireless local area network (WLAN) (Wi-Fi, wireless broadband (Wibro), world interoperability for microwave access (Wimax), code-division multiple access (CDMA), or wideband code division multiple access (WCDMA). The transceiver 1210 according to an embodiment of the disclosure may receive data related to a user, a product, or marketing from an intranet or an online service with which the user interacts.

The processor 1220 controls an overall operation of the electronic device 10. For example, the processor 1220 may execute instructions stored in the memory 1230 to identify the user's purchase intention, a product combination, the user's suitability for the product combination, a discount rate of the product combination, or a priority of the product combination or the discount rate, by using the data received through the transceiver 1210. In an embodiment of the disclosure, the processor 1220 may perform preprocessing on the obtained data to be suitable for an AI model. The processor 1220 may input the data to the AI model and may output the user's purchase intention, the product combination, and the discount rate as output values. The processor 1220 may perform reinforcement learning by reflecting the user's feedback information. In an embodiment of the disclosure, the processor 1220 may include a plurality of processors.

The memory 1230 may store program commands or code executed in the processor 1220, and may store input/output data (e.g., the data on the user, the product, or the marking and the user's feedback). In an embodiment of the disclosure, the memory 1230 may include a plurality of memories.

The memory 1230 may include at least one type of storage medium from among a flash memory type, a hard disk type, a multimedia card micro type, a card type memory (e.g., a secure digital (SD) or extreme digital (XD) memory), a random-access memory (RAM), a static random-access memory (SRAM), a read-only memory (ROM), an electrically erasable programmable read-only memory (EEPROM), a programmable read-only memory (PROM), a magnetic memory, a magnetic disk, and an optical disk.

In an embodiment of the disclosure, the memory 1230 may store the data obtained through the transceiver 1210 and the data preprocessed to be applied to the AI model. The data may include data on the user, the product, and the marking, and may include time information obtained while the user interacts with the online service, but the disclosure is not limited thereto.

In an embodiment of the disclosure, the memory 1230 may include a plurality of modules. A purchase intention identification module 1240 may identify the user's purchase intention by using the obtained data or the preprocessed data as an input value. The purchase intention identification module 1240 may output ‘1’ (or ‘0’) when it is identified that the user's purchase intention exists and may output ‘0’ (or ‘1’) when it is identified that there is no user's purchase intention.

When it is identified that the user's purchase intention exists, a product combination and discount rate identification module 1250 may identify a product combination including a plurality of products. The product combination and discount rate identification module 1250 may identify a product combination including two or more products belonging to different product groups by using the obtained data, the preprocessed data, or the user's feedback information. Also, when the user's suitability for the identified product combination is equal to or greater than a preset value, the product combination and discount rate identification module 1250 may identify a discount rate in a valid integer range by considering information about the product (e.g., a price of the product, a margin, and a flagship).

A reward value acquisition module 1260 according to the feedback may obtain a reward value according to a feedback obtained by providing a promotion including the identified product combination and discount rate to the user. The reward value may have a different value according to whether the user has viewed the product combination through the promotion or whether the user has paid. The electronic device 10 may adjust the product combination and the discount rate through reinforcement learning using the reward value according to the feedback.

In an embodiment of the disclosure, a method by which the electronic device 10 provides a service to a user may involve obtaining data related to at least one of the user, a plurality of products, or marketing, and identifying the user's purchase intention based on the obtained data. The method according to an embodiment of the disclosure may involve identifying at least one product combination including two or more products from among the plurality of products and a discount rate of the at least one product combination by applying the identified user's purchase intention and data to an AI model. The method according to an embodiment of the disclosure may involve providing the at least one product combination and the discount rate.

In an embodiment of the disclosure, the method may involve identifying the at least one product combination and the discount rate by using a hidden layer of the AI model.

In an embodiment of the disclosure, the data may include at least one of the user's behavior data, data related to a web page, data on a viewed product, data on the marketing, or data on a time.

In an embodiment of the disclosure, the AI model may be a reinforcement learning AI model trained to infer the at least one product combination and the discount rate for the plurality of products.

In an embodiment of the disclosure, the method may involve receiving a reward value according to the user's feedback on the at least one product combination and the discount rate based on a reward function and adjusting the discount rate based on the received reward value.

In an embodiment of the disclosure, the method may involve identifying a product combination based on data including at least one of the user's preference for a product group, preference for a product group for each path through which the user enters, preference for a product group for each digital marketing provided to the user, or preference for the discount rate.

In an embodiment of the disclosure, the method may involve identifying a discount rate in case that the user's suitability for the at least one product combination is equal to or greater than a preset value.

In an embodiment of the disclosure, the method may involve identifying a priority of the user for the at least one product combination and the discount rate. The method according to an embodiment of the disclosure may involve determining an arrangement order of the at least one product combination and the discount rate based on the identified priority, and providing the at least one product combination and the discount rate based on the arrangement order.

In an embodiment of the disclosure, the method may involve identifying the at least one product combination by applying the reward value according to the user's feedback and data to the AI model.

In an embodiment of the disclosure, the data may include data on at least one of an offline promotion, a marketing campaign, or a channel-specific advertisement.

In an embodiment of the disclosure, the discount rate may be identified based on a margin or a flagship of the plurality of products.

In an embodiment of the disclosure, the data may include a time that the user interacts with the plurality of products.

In an embodiment of the disclosure, the data may include a time at which the product combination is identified or a time at which the discount rate is identified, and a weight value of each of the data may be set based on the time.

In an embodiment of the disclosure, the at least one product combination may include two or more products belonging to different product groups from among the plurality of products.

In an embodiment of the disclosure, an electronic device for providing a service to a user may include a transceiver, a memory in which one or more instructions are stored, and at least one processor configured to execute the one or more instructions. The at least one processor may be further configured to obtain data related to at least one of the user, a plurality of products, or marketing, and identify the user's purchase intention based on the data. The electronic device according to an embodiment of the disclosure may apply the identified user's purchase intention and the data to an AI model to identify at least one product combination including two or more products from among the plurality of products and a discount rate of the at least one product combination. The electronic device according to an embodiment of the disclosure may provide the at least one product combination and the discount rate.

In an embodiment of the disclosure, a computer-readable recording medium may perform the above methods by recording a program to be executed on a computer.

A machine-readable storage medium may be provided as a non-transitory storage medium. In one or more examples, ‘non-transitory’ may mean that the storage medium does not include a signal (e.g., an electromagnetic wave) and is tangible, but does not distinguish whether data is stored semi-permanently or temporarily in the storage medium. For example, the ‘non-transitory storage medium’ may include a buffer in which data is temporarily stored.

According to an embodiment of the disclosure, methods according to various embodiments of the disclosure may be provided in a computer program product. The computer program product is a product purchasable between a seller and a purchaser. The computer program product may be distributed in the form of a machine-readable storage medium (e.g., a compact disc read-only memory (CD-ROM)), or distributed (e.g., downloaded or uploaded) online via an application store or between two user devices (e.g., smartphones) directly. When distributed online, at least part of the computer program product (e.g., a downloadable application) may be temporarily generated or at least temporarily stored in a machine-readable storage medium, such as a memory of a server of a manufacturer, a server of an application store, or a relay server.

What is claimed is:

1. A method by which an electronic device provides a service to a user, the method comprising:
obtaining data related to at least one of the user, a plurality of products, or one or more marketing activities;
identifying a purchase intention of the user based on the data;
identifying at least one product combination comprising at least two products from among the plurality of products and a discount rate of the at least one product combination by applying the purchase intention of the user and the data to an artificial intelligence (AI) model; and
displaying the at least one product combination and the discount rate.

2. The method of claim 1, wherein the data comprises at least one of behavior data of the user, data related to a web page, data on a viewed product, data on the marketing, or data on a time corresponding to the behavior data.

3. The method of claim 1, wherein the AI model is a reinforcement learning AI model trained to infer the at least one product combination and the discount rate for the plurality of products.

4. The method of claim 1, wherein the identifying of the at least one product combination and the discount rate comprises:
receiving, based on a reward function, a reward value according to feedback of the user on the at least one product combination and the discount rate; and
adjusting the discount rate based on the reward value.

5. The method of claim 1, wherein the identifying of the at least one product combination and the discount rate comprises identifying, based on data comprising at least one of a preference for a product group, a preference for a product group for each path in a web page through which the user enters to view the product group, a preference for a product group for each digital marketing provided to the user, or a preference according to the discount rate.

6. The method of claim 1, further comprising identifying the discount rate based on a determination that a suitability of the user for the at least one product combination is equal to or greater than a preset value.

7. The method of claim 1, wherein the displaying of the at least one product combination and the discount rate further comprises:
identifying a priority of the user for the at least one product combination and the discount rate;
determining an arrangement order of the at least one product combination and the discount rate based on the priority; and
displaying the at least one product combination and the discount rate based on the arrangement order.

8. The method of claim 1, wherein the identifying of the at least one product combination and the discount rate comprises identifying the at least one product combination by applying the data and a reward value according to feedback of the user to the AI model.

9. The method of claim 1, wherein the data comprises a time that the user interacts with the plurality of products.

10. The method of claim 1, wherein the data comprises a first time at which the at least one product combination is identified or a second time at which the discount rate is identified, and
wherein a weight value is set for each of the data based on the first time or the second time.

11. An electronic device for providing a service to a user, the electronic device comprising:
a transceiver;
a memory in which at least one instruction is stored;
at least one processor configured to execute the at least one instruction to:
obtain data related to at least one of the user, a plurality of products, or one or more marketing activities,
identify a purchase intention of the user based on the data,
identify at least one product combination comprising at least two products from among the plurality of products and a discount rate of the at least one product combination, by applying the purchase intention of the user and the data to an artificial intelligence (AI) model, and
display, the at least one product combination and the discount rate.

12. The electronic device of claim 11, wherein the data comprises at least one of behavior data of the user, data related to a web page, data on a viewed product, data on the marketing, or data on a time corresponding to the behavior data.

13. The electronic device of claim 11, wherein the AI model is a reinforcement learning AI model trained to infer the at least one product combination and the discount rate for the plurality of products.

14. The electronic device of claim 11, wherein the at least one processor is further configured to execute the at least one instruction to:
receive, based on a reward function, a reward value according to feedback of the user on the at least one product combination and the discount rate, and
adjust the discount rate based on the reward value.

15. The electronic device of claim 11, wherein the at least one processor is further configured to execute the at least one instruction to identify the discount rate in case that a suitability of the user for the at least one product combination is equal to or greater than a preset value.

16. The electronic device of claim 11, wherein the at least one processor is further configured to execute the at least one instruction to:
identify a priority of the user for the at least one product combination and the discount rate,
determine an arrangement order of the at least one product combination and the discount rate based on the priority, and
provide the at least one product combination and the discount rate based on the arrangement order.

17. The electronic device of claim 11, wherein the at least one processor is further configured to execute the at least one instruction to identify the at least one product combination by applying the data and a reward value according to feedback of the user to the AI model.

18. The electronic device of claim 11, wherein the data comprises a time that the user interacts with the plurality of products.

19. The electronic device of claim 11, wherein the data comprises a first time at which the at least one product combination is identified or a second time at which the discount rate is identified, and
wherein a weight value is set for each of the data based on the first time or the second time.

20. A non-transitory computer-readable recording medium having recorded thereon a program which is executable by a computer to perform the method of claim 1.
